(19) United States
(12) Patent Application Publication
(10) Pub. No.: US 2014/0152447 A1
(43) Pub. Date: Jun. 5, 2014

(54) ETHERNET DEVICE CAPABLE OF INDICATING STATUS AND METHOD THEREOF

(71) Applicant: HON HAI PRECISION INDUSTRY CO., LTD., New Taipei (TW)

(72) Inventor: HUNG-TA CHEN, New Taipei (TW)

(73) Assignee: HON HAI PRECISION INDUSTRY CO., LTD., New Taipei (TW)

(21) Appl. No.: 13/968,375

(22) Filed: Aug. 15, 2013

(30) Foreign Application Priority Data
Dec. 3, 2012 (TW) 101145257

(51) Int. Cl. G08B 21/18

(52) U.S. Cl. CPC G08B 21/18
USPC 340/635

(57) ABSTRACT

A method for an Ethernet device indicating a number of states in relation to electrical power available and the good or bad status of electrical connections detects connections between terminal devices and connection ports of the Ethernet device. An indication unit displays no indication signal in the absence of any connection and detects the good or bad status of any connections which are detected. If a connection is bad, the indication device is controlled to produce an indication signal but in the absence of any bad connections, obtains and quantifies a residual power of a power module to determine the number of terminal devices which the Ethernet can be deemed able to support, the different numbers of supportable terminal devices being indicated by different signals.

### BACKGROUND

1. Technical Field

The present disclosure relates to Ethernet devices.

2. Description of Related Art

Power over Ethernet (PoE) is in common use. PoE functions when an Ethernet device such as a router, a concentrator, or an Ethernet switch is connected to a network terminal, such as an voice over internet protocol (VOIP) telephone, a wireless local area network (WLAN) access point, or a network camera, and the Ethernet device not only communicates with the network terminal, but also provides power to the network terminal. However, the Ethernet device of related art does not provide information for the user except the on or off status.

An Ethernet device and a method to overcome the described limitations are thus needed.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a block diagram of a first embodiment of an Ethernet device capable of indicating status.

FIG. 2 is a block diagram of a second embodiment of an Ethernet device capable of indicating status.

FIG. 3 is a flowchart illustrating a first embodiment of a method of indicating status.

FIG. 4 is a flowchart illustrating a second embodiment of a method of indicating status.

### DETAILED DESCRIPTION

Embodiments of the present disclosure will be described with reference to the accompanying drawings.

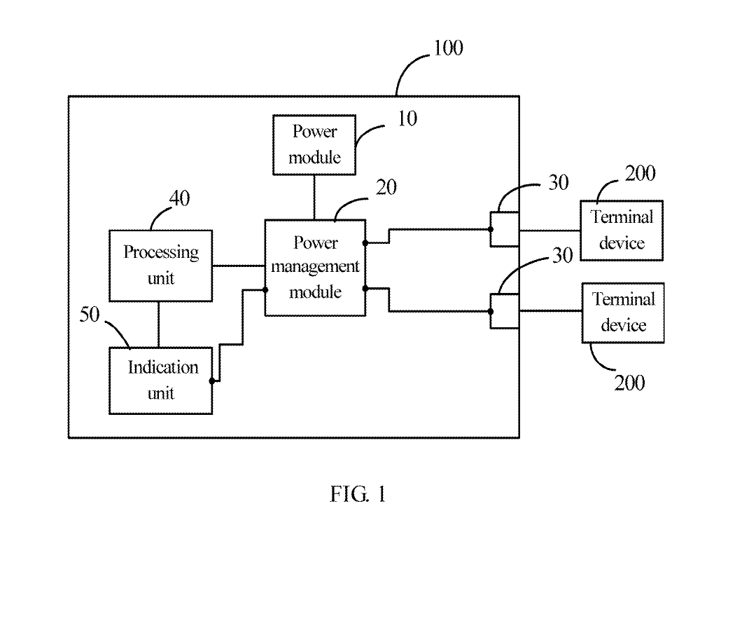

FIG. 1 illustrates a block diagram of a first embodiment of an Ethernet device 100 capable of indicating status. The Ethernet device 100 includes a power module 10, a power management module 20, a number of connect ports 30, a processing unit 40, and an indication unit 50. The Ethernet device 100 is capable of indicating a number of statuses regarding power and connections.

The power module 10 is used to provide power. The power management module 20 is connected to the power module 10 and is used to distribute power from the power source to the Ethernet device 100. In the embodiment, the power management module 20 is also connected to the connect ports 30, the processing unit 40, and the indication unit 50, and distributes suitable voltages to the connect ports 30, the processing unit 40, and an indication unit 50. The connect ports 30 connect to different types of terminal devices 200, such as a voice over internet protocol (VOIP) telephone, a wireless local area network (WLAN) access point, or a network camera. When one connect port 30 is connected to a terminal device 200, the power management module 20 distributes the suitable voltage to the terminal device 200 via the connect port 30.

The power management unit 20 detects the amount of electrical power remaining and available in the power module 10 (residual power). The processing unit 40 obtains the level of residual power of the power module 10 as detected by the power management unit 20, and determines a quantity of the terminal devices 200 can be sufficiently powered by the residual power of the power module 10. The processing unit 40 also controls the indication unit 50 to produce a first indication signal when a determination is made that the quantity of the terminal devices 200 which can be powered by the residual power of the power module 10 is not more/greater than one. The processing unit 40 also controls the indication unit 50 to produce a second indication signal when a determination is made that the quantity of the terminal devices 200 which can be powered by the residual power of the power module 10 is greater than one.

In the embodiment, an amount of power provided to each connect port 30 is deemed to be the same, that is, the amount of power consumed by each terminal device 200 is regarded as being the same, such as 13 watts. The processing unit 40 pre-stores the amount of power consumed by one terminal device 200, and compares the residual power of the power module 10 and the pre-stored power consumed by one terminal device 200 to make determinations as to the quantity of the terminal devices 200 which can be powered by the power module 10.

The power management unit 20 is also used to obtain a total output of power to the terminal devices 200 when the power management unit 20 distributes the power to the terminal devices 200 connected to the connect ports 30. The processing unit 40 also determines a utilization ratio of the power module 10 according to the total output of power to the terminal devices 200 and the residual power of the power module 10. The processing unit 40 is also used to control the indication unit 50 to produce a third indication signal when a determination is made that the utilization ratio of the power module 10 is greater than a predetermined value, such as 70%. The processing unit 40 also controls the indication unit 50 to produce a fourth indication signal when determining that the utilization ratio of the power module 10 is not greater than the predetermined value. In the embodiment, the utilization ratio is equal to a ratio between the total output of power to the terminal devices 200 and the residual power of the power module 10.

In the embodiment, the indication unit 50 is a light-emitting unit (LED), such as an aluminium gallium indium phosphide (AlInGaP) LED, in which, when the current flowing through the indication unit 50 changes, the color of the light emitted by such LED also changes. In the embodiment, the indication unit 50 is connected to the power management unit 20, the processing unit 40 controls the power management unit 20 to output a level of current to the indication unit 50 to make the indication unit 50 emit light of a certain color. For example, when the value of the current flowing through the indication unit 50 is increased in steps, the indication unit 50 in turn emits red, orange, yellow, and green light for the steps. In the embodiment, the first indication signal, the second indication signal, the third indication signal, and the fourth indication signal produced by the indication unit 50 respectively are red light, orange light, yellow light, and green light.

The processing unit 40 controls the power management unit 20 to output a first current to the indication unit 50 to cause the indication unit 50 to emit red light, after determining that the residual power of the power module 10 can power not more than one terminal device 200. The processing unit 40 controls the power management unit 20 to output a second current greater than the first current to the indication unit 50 to cause the indication unit 50 to emit orange light, after determining that the residual power of the power module 10 can power more than one terminal device 200. The processing unit 40 also controls the power management unit 20 to output a third current greater than the second current to the indication unit 50 to cause the indication unit 50 to emit yellow light, after determining that the utilization ratio of the power module 10 is greater than the predetermined value of 70%. The processing unit 40 also controls the power management unit 20 to output a fourth current greater than the third current to the indication unit 50 to cause the indication unit 50 to emit green light, after determining that the utilization ratio of the power module 10 is not greater than the predetermined value.

In the embodiment, the power module 10 can be a lithium battery or a nickel-metal hydride battery.

In another embodiment, the indication unit 50 is a display, and the first indication signal, the second indication signal, the third indication signal, and the fourth indication signal are different images or different messages. The processing unit 40 controls the indication unit 50 to display an indication signal directly.

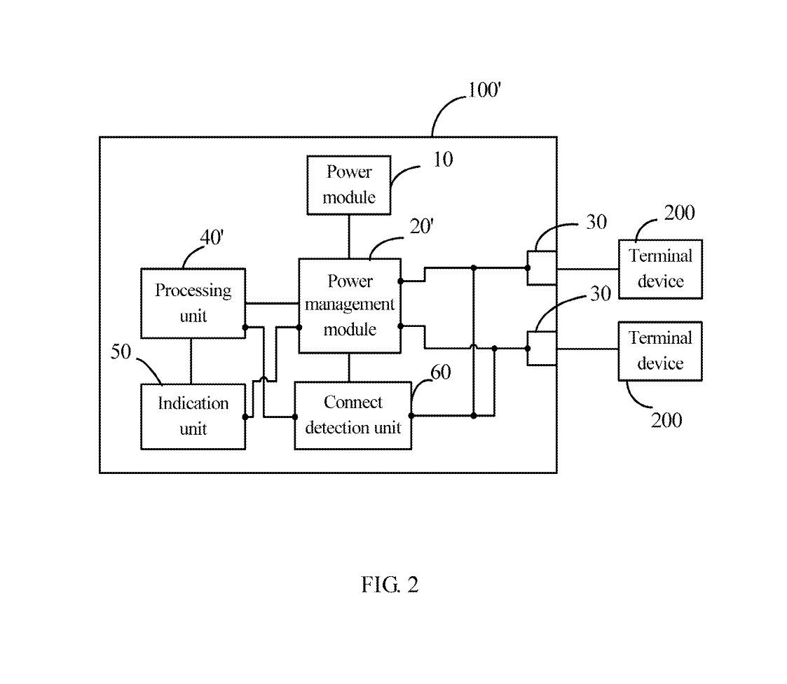

Referring to FIG. 2, in a second embodiment, the Ethernet device 100′ includes the power module 10, a power management unit 20′, the number of connect ports 30, a processing unit 40′, the indication unit 50, and a connect detection unit 60.

In the embodiment, the power module 10 is used to provide power. The power management module 20′ is connected to the power module 10 and is used to distribute power from the power source to the Ethernet device 100′. The power management module 20′ is also connected to the connect ports 30, the processing unit 40′, and the indication unit 50, and is used to distribute suitable voltages to the connect ports 30, the processing unit 40′, and an indication unit 50. The connect ports 30 connect to different types of terminal devices 200, such as a voice over internet protocol (VOIP) telephone, a wireless local area network (WLAN) access point, or a network camera. When one connect port 30 is connected to a terminal device 200, the power management module 20 distributes the suitable voltage to the terminal device 200 via the connect port 30.

The connect detection unit 60 is connected to the number of connect ports 30 and the processing unit 40′, and detects a state of each connect port 30. The processing unit 40′ controls the indication unit 50 to produce indication signals according to the states of the connect ports 30.

In the second embodiment, the connect detection unit 60 can detect whether at least one connect port 30 is connected to a terminal device 200. When the connect detection unit 60 detects that no connect port 30 is connected to a terminal device 200, the processing unit 40′ controls the indication unit not to produce any indication signal. When the connect detection unit 60 detects that at least one connect port 30 is connected to a terminal device 200, the processing unit 40′ controls the connect detection unit 60 to detect whether connections between each connect port 30 and each terminal device 200 are good.

In the second embodiment, when the connect detection unit 60 detects a bad connection between one connect port 30 and the connected terminal device 200, the processing unit 40′ controls the indication unit 50 to produce a first indication signal.

When the connect detection unit 60 detects a good connection between each connect port 30 and the connected terminal device 200, the processing unit 40 controls the power management 20′ to detect the residual power of the power module 10, and then the processing unit 40′ determines whether the residual power of the power module 10 is sufficient to power at least one terminal device 200.

The processing unit 40′ controls the indication unit 50 to produce a second indication signal after determining that the residual power of the power module 10 is not sufficient to power one terminal device 200. The processing unit 40′ also controls the indication unit to produce a third indication signal after determining that the residual power of the power module 10 can power at least one terminal device 200.

As in the first embodiment, in the second embodiment, the processing unit 40′ pre-stores the power consumed by one terminal device 200, and compares the residual power of the power module 10 and the power consumed by one terminal device 200 to determine whether the residual power of the power module 10 can power at least one terminal device 200.

In the second embodiment, the indication unit 50 is a light-emitting unit (LED) and is connected to the power management unit 20′, the processing unit 40′ controls the power management unit 20′ to output different currents to the indication unit 50 to cause the indication unit 50 to emit light of different colors, thus producing the first indication signal, the second indication signal, and the third indication signal. In the second embodiment, the processing unit 40′ controls the indication unit 50 not to produce any indication signal by controlling the power management unit 20 not to output any current to the indication unit 50. The indication unit 50 also can be a display, and the first indication signal, the second indication signal, and the third indication signal may be different images or different messages. The processing unit 40′ controls the indication unit 50 to display the indication signal directly.

The Ethernet device 200 can be a router, a concentrator, or an Ethernet switch, in the first embodiment and the second embodiment.

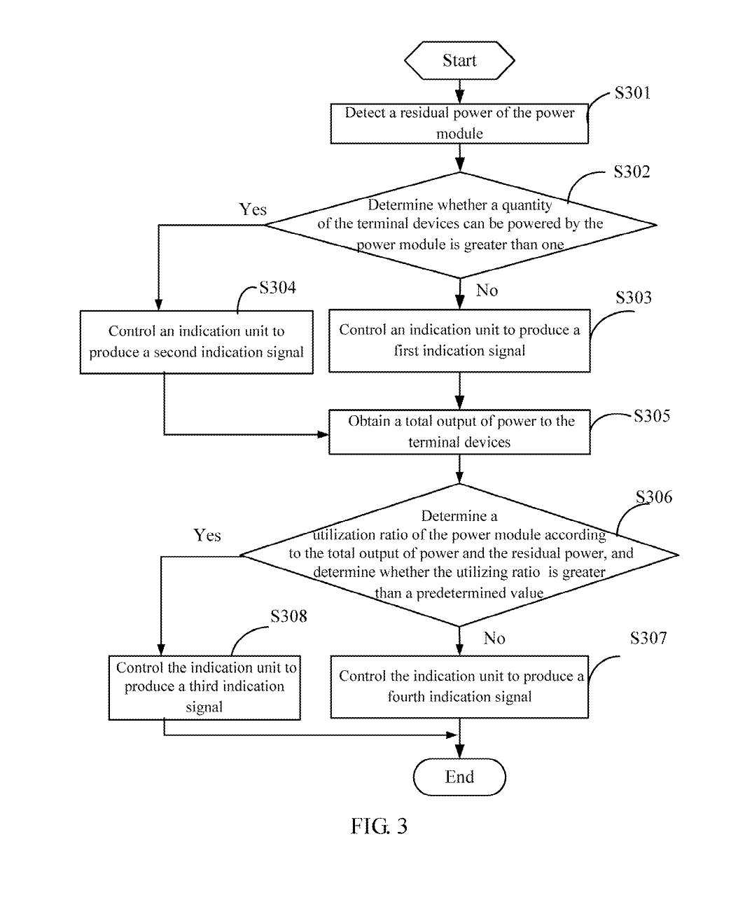

FIG. 3 illustrates a method for indicating status of the Ethernet device 100 of a first embodiment. At first, the power management unit 20 detects a residual power of the power module (S301).

The processing unit 40 obtains the level of residual power of the power module 10 as detected by the power management unit 20, and determines a quantity of the terminal devices 200 which can be powered by the residual power of the power module (S302). In detail, the processing unit 40 pre-stores the level of power consumed by one terminal device 200, and compares the residual power of the power module 10 and the power consumed by one terminal device 200 to determine the total quantity of the terminal devices 200 which can be powered by the power module 10.

The processing unit 40 controls the indication unit 50 to produce the first indication signal after determining that the quantity of the terminal devices 200 which can be powered by the residual power of the power module 10 is not greater than one (S303).

The processing unit controls the indication unit 50 to produce the second indication signal after determining that the quantity of the terminal devices 200 which can be powered by the residual power of the power module 10 is greater than one (S304).

The power management unit 20 obtains the total output of power to the terminal devices 200 when the power management unit 20 distributes power to the terminal devices 200 connected to the connect ports 30 (S305).

The processing unit 40 also determines a utilization ratio of the power module 10 according to the total output of power to the terminal devices 200 and the residual power of the power module 10, and determines whether the utilization ratio of the power module 10 is greater than a predetermined value (S306).

The processing unit 40 also controls the indication unit 50 to produce the third indication signal after determining that the utilization ratio of the power module 10 is greater than the predetermined value (S307).

The processing unit 40 also controls the indication unit 50 to produce the fourth indication signal after determining that the utilization ratio of the power module 10 is not greater than the predetermined value (S308).

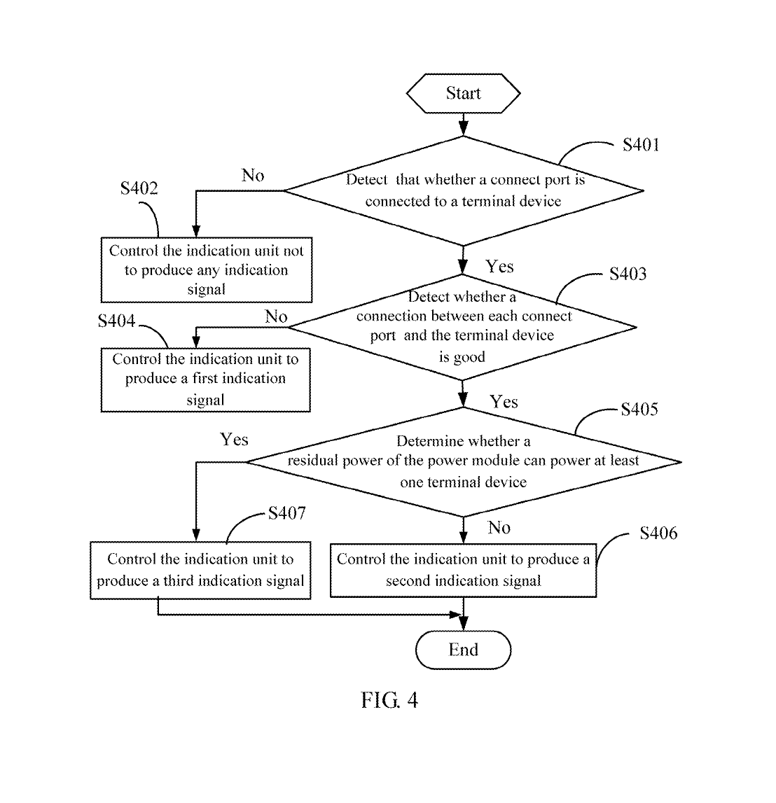

FIG. 4 illustrates a method for indicating status of the Ethernet device 100 of a second embodiment. At first, the connect detection unit 60 detects whether there is a connect port 30 connected to a terminal device 200 (S401).

The processing unit 40′ controls the indication unit 50 not to produce any indication signal when the connect detection unit 60 detects that no connect port 30 is connected to a terminal device 200 (S402).

The processing unit 40′ controls the connect detection unit 60 to detect whether a connection between each connect port 30 and a connected terminal device 200 is good or bad when the connect detection unit 60 detects at least one connect port 30 connected to a terminal device 200 (S403).

The processing unit 40′ controls the indication unit 50 to produce the first indication signal when the connect detection unit 60 detects that the connection between one connect port 30 and a connected terminal device 200 is bad (S404).

The processing unit 40′ obtains the residual power of the power module 10 detected by the power management 20′, and then determines whether the residual power of the power module 10 can power at least one terminal device, when the connect detection unit 60 detects that the connection between each connect port 30 and each connected terminal device 200 is good (S3405).

The processing unit 40′ controls the indication unit to produce the second indication signal after determining that the residual power of the power module 10 cannot power one terminal device 200 (S406).

The processing unit 40′ controls the indication unit 50 to produce the third indication signal after determining that the residual power of the power module 10 can power at least one terminal device 200 (S407).

Therefore, the Ethernet device 100 and the method for indicating status of the Ethernet device 100, not only indicates a number of power statuses, but can also indicate a good or a bad connection status.

It is understood that the present embodiments and their advantages will be understood from the foregoing description, and various changes may be made thereto without departing from the spirit and scope of the disclosure or sacrificing all of its material advantages, the examples hereinbefore described merely being embodiments of the present disclosure.

What is claimed is:

1. An Ethernet device capable of indicating status, comprising:
a power module configured to provide power;
a plurality of connect ports configured to connect to different types of terminal devices;
an indication unit;
a processing unit configured to control the indication unit to produce indication signal; and
a power management module connected to the power module, the plurality of connect ports, the indication unit, and the processing unit, and configured to distribute power from the power module to the plurality of connect ports, the processing unit, and the indication unit, and to detect a residual power of the power module;
wherein, the processing unit is further configured to obtain residual power of the power module detected by the power management unit, and determine a quantity of the terminal devices that can be powered by the residual power of the power module, to control the indication unit to produce a first indication signal after determining that the quantity of the terminal devices can be powered by the residual power of the power module is not greater than one, and to control the indication unit to produce a second indication signal after determining that the quantity of the terminal devices can be powered by the residual power of the power module is greater than one.

2. The Ethernet device according to claim 1, wherein the power management unit is further configured to obtain a total output of power to the terminal devices when the power management unit distributes the power to the terminal devices connected to the connect ports, the processing unit further determines a utilization ratio of the power module according to the total output of power to the terminal devices and the residual power of the power module, and controls the indication unit to produce a third indication signal after determining that the utilization ratio of the power module is greater than a predetermined value.

3. The Ethernet device according to claim 2, wherein the processing unit is further configured to control the indication unit to produce a fourth indication signal after determining that the utilization ratio of the power module is not greater than the predetermined value.

4. The Ethernet device according to claim 3, wherein the indication unit is a light-emitting unit and is connected to the power management unit, the processing unit controls the power management unit to output a different current to the indication unit to cause the indication unit to emit light with different colors to produce the first indication signal, the second indication signal, the third indication signal, and the fourth indication signal.

5. The Ethernet device according to claim 3, wherein the indication unit is a display, and the first indication signal, the second indication signal, the third indication signal, and the fourth indication signal are different images or messages, the processing unit controls the indication unit to display the corresponding indication signal directly.

6. The Ethernet device according to claim 1, wherein the processing unit pre-stores the power consumed by one terminal device, and compares the residual power of the power module and the power consumed by one terminal device to determine the quantity of the terminal device can be powered by the power module.

7. An Ethernet device capable of indicating status, comprising:
a power module configured to provide power;
a plurality of connect ports configured to connect to different types of terminal devices;
a connect detection unit configured to detect a state of each connect port;
an indication unit,
a processing unit connected to the connect detection unit and the indication unit, and configured to control the indication unit to produce indication signals, and
a power management module connected to the power module, the plurality of connect ports, the connect detection unit, and the processing unit, and configured to distribute power from the power module to the processing unit, and the connect detection unit, and to distribute power to the terminal devices connected to the connect ports via the connect ports;
wherein, when the connect detection unit detects that none of the connect ports is connected to the terminal device, the processing unit controls the indication unit not to produce any indication signal; when the connect detection unit detects that there is at least one connect port is connected to the corresponding terminal device, the processing unit controls the connect detection unit to detect whether a connection between each connect port and the corresponding terminal device is good or bad, and controls the indication unit to produce a first indication signal when the connect detection unit detects the connection between one connect port and the corresponding terminal device is bad.

8. The Ethernet device according to claim 7, wherein when the connect detection unit detects the connection between each connect port and the corresponding terminal device is good, the processing unit controls the power management to detect the residual power of the power module, and determines whether the residual power of the power module can power at least one terminal device; the processing unit further controls the indication unit to produce a second indication signal after determining that the residual power of the power module can not power at least one terminal device, and controls the indication unit to produce a third indication signal after determining that the residual power of the power module can power at least one terminal device.

9. The Ethernet device according to claim 8, wherein the indication unit is a light-emitting unit and is connected to the power management unit, the processing unit controls the power management unit to output different current to the indication unit to cause the indication unit to emit light with different colors to produce the first indication signal, the second indication signal, and the third indication signal; the processing unit controls the power management unit not to output any current to the indication unit to cause the indication unit not to produce any indication signals.

10. The Ethernet device according to claim 8, wherein the indication unit is a display, and the first indication signal, the second indication signal, and the third indication signal are different images or messages, the processing unit controls the indication unit to display the corresponding indication signal directly.

11. The Ethernet device according to claim 7, the processing unit pre-stores the power consumed by one terminal device, and compares the residual power of the power module and the power consumed by one terminal device to determine the quantity of the terminal device can be powered by the power module.

12. A method for indicating status of an Ethernet device, the Ethernet device comprises a power module, an indication unit, and a plurality of connect ports, the method comprising:
detecting a residual power of a power module;
obtaining the residual power of the power module, and determining a quantity of the terminal devices can be powered by the residual power of the power module;
controlling the indication unit to produce a first indication signal after determining that the quantity of the terminal devices can be powered by the residual power of the power module is not greater than one;
controlling the indication unit to produces a second indication signal after determining that the quantity of the terminal devices can be powered by the residual power of the power module is greater than one.

13. The method according to claim 12, further comprising:
obtaining a total output of power to the terminal devices when the power management unit distributes the power to the terminal devices connected to the connect ports;
determining a utilization ratio of the power module according to the total output of power to the terminal devices and the residual power of the power module, and determining whether the utilization ratio of the power module is greater than a predetermined value;
controlling the indication unit to produce a third indication signal after determining that the utilization ratio of the power module is greater than the predetermined value; and
controlling the indication unit to produce a fourth indication signal after determining that the utilization ratio of the power module is not greater than the predetermined value.

14. The method according to claim 12, wherein the step of determining a quantity of the terminal devices can be powered by the residual power of the power module comprise:
comparing a residual power of the power module and a power consumed by one terminal device to determine the quantity of the terminal device can be powered by the power module.
